(19) United States
(12) Patent Application Publication
(10) Pub. No.: US 2024/0165927 A1
(43) Pub. Date: May 23, 2024

(54) SLIDING MAT

(71) Applicant: Zhejiang Feier Intelligent Technology Co., Ltd., Hangzhou (CN)

(72) Inventors: Longfei Wang, Dingzhou City (CN); Lanyi Qu, Jilin City (CN)

(21) Appl. No.: 18/164,474

(22) Filed: Feb. 3, 2023

(30) Foreign Application Priority Data
Nov. 21, 2022 (CN) 202223108666.8

(51) Int. Cl. B32B 25/08; B32B 5/02; B32B 7/12; B32B 25/10; B32B 27/32

(52) U.S. Cl. CPC B32B 25/08; B32B 5/028; B32B 7/12; B32B 25/10; B32B 27/32; B32B 2307/51; B32B 2307/7376; B32B 2307/744; B32B 2471/04

(57) ABSTRACT

The utility model discloses a sliding mat, including: a non-slip mat layer located at a lower portion; a smooth panel layer located at an upper portion; a mesh layer bonded on the non-slip mat layer via thermal compounding and located between the non-slip mat layer and the smooth panel layer; and a hot melt adhesive layer penetrating the mesh layer and configured to bond the smooth panel layer and the non-slip mat layer together. According to the technical solution of the utility model, the smooth panel layer and the non-slip mat layer are arranged on opposite sides of the mesh layer, respectively. The smooth panel layer is arranged on an upper portion of the sliding mat, and a side of the smooth panel layer far away from the mesh layer is arranged as a smooth surface. The mesh layer is bonded to a surface of the non-slip mat layer via a thermal compounding process. At the same time, the hot melt adhesive layer is arranged between the smooth panel layer and the non-slip mat layer. The hot melt adhesive layer permeates the mesh layer, so that the smooth panel layer, the mesh layer, and the non-slip mat layer are relatively fixed. The mesh layer is thermally compounded to the non-slip mat layer, and the hot melt adhesive layer permeates the mesh layer, thereby effectively improving a tensile strength of the sliding mat, and further improving practicability of the sliding mat.

### TECHNICAL FIELD

The utility model relates to the field of a fitness equipment, and in particular, to a sliding mat.

### TECHNICAL BACKGROUND

With development of society and change of a living environment, people's demand for home exercise is getting higher and higher. Especially in recent years, the global epidemic repeated, and it is often necessary to be isolated at home and not go out to exercise. Therefore, a user has an increasing demand for home fitness equipment. For most users, large fitness equipment is inconvenient to install at home, so small fitness equipment is more popular with the users.

However, sports require high self-discipline, and require the users to overcome laziness. However, common small fitness equipment, such as dumbbells, kettlebells or a push-up bracket, is too common in daily life, so it is not interesting when exercising at home, thus affecting enthusiasm of the user for exercise.

In view of this, the applicant developed a sliding mat. As the new fitness equipment, the sliding mat can effectively enhance the enthusiasm of the user for sports, and then improve an effect of the user' home sports.

### SUMMARY

An objective of the utility model is to provide a sliding mat, aiming at improving practicability of fitness equipment.

In order to achieve the forgoing objective, the sliding mat provided by the utility model includes:
a non-slip mat layer located at a lower portion;
a smooth panel layer located at an upper portion;
a mesh layer bonded on the non-slip mat layer by thermal compounding and located between the non-slip mat layer and the smooth panel layer; and,
a hot melt adhesive layer penetrating the mesh layer and configured to bond the smooth panel layer and the non-slip mat layer together.

Optionally, the sliding mat also includes fixing members fixed at opposite ends of the non-slip mat layer.

Optionally, the fixing member is provided with an inserting opening. A fixing column is arranged inside the fixing member. Fixing holes are arranged at the opposite ends of the non-slip mat layer. The non-slip mat layer is inserted into the fixing member through the inserting opening, and the fixing column is located in the fixing hole.

Optionally, the smooth panel layer is made of a polypropylene material containing a slipping agent.

Optionally, the mesh layer is made of mutispandex.

Optionally, the non-slip mat layer is made of rubber.

Optionally, a bottom of the non-slip mat layer is provided with a non-slip structure.

Optionally, the non-slip structure has a concave-convex mesh texture.

Optionally, the smooth panel layer has a thickness of no more than 0.8 mm and no less than 0.4 mm, and the non-slip mat layer has a thickness of no more than 5 mm and no less than 1 mm.

The smooth panel layer, the mesh layer, and the non-slip mat layer have a length of no more than 2400 mm and no less than 1400 mm. The smooth panel layer, the mesh layer, and the non-slip mat layer have a width of no more than 700 mm and no less than 300 mm.

A sliding mat includes;
a non-slip mat layer located at a lower portion, and made of rubber;
a smooth panel layer located at an upper portion, the smooth panel layer being made of a polypropylene material containing a slipping agent;
a mesh layer bonded on the non-slip mat layer via thermal compounding and located between the non-slip mat layer and the smooth panel layer, and the mesh layer being made of mutispandex; and,
a hot melt adhesive layer penetrating the mesh layer and configured to bond the smooth panel layer and the non-slip mat layer together.

According to the technical solution of the utility model, the smooth panel layer and the non-slip mat layer are arranged on opposite sides of the mesh layer, respectively. The smooth panel layer is arranged on an upper portion of the sliding mat, and a side of the smooth panel layer far away from the mesh layer is arranged as a smooth surface so that a user slides on the smooth surface to achieve a fitness effect. The mesh layer is bonded to a surface of the non-slip mat layer via a thermal compounding process. At the same time, the hot melt adhesive layer is arranged between the smooth panel layer and the non-slip mat layer. The hot melt adhesive layer permeates the mesh layer, so that the smooth panel layer, the mesh layer, and the non-slip mat layer are relatively fixed. The mesh layer is thermally compounded to the non-slip mat layer, and the hot melt adhesive layer permeates the mesh layer, thereby effectively improving a structural strength of the sliding mat, and further improving practicability of the sliding mat.

### BRIEF DESCRIPTION OF THE DRAWINGS

In order to explain embodiments of the utility model or the technical solutions in the prior art more clearly, the following briefly introduces the drawings that need to be used in the description of the embodiments or the prior art. Obviously, the drawings in the following description are only some of the embodiments of the utility model. The person skilled in the art may obtain other drawings based on structures shown in these drawings without creative labor.

FIG. 1 is a schematic diagram of a decomposed structure of an embodiment of a sliding mat of the utility model.

FIG. 2 is a sectional diagram of a smooth panel layer, a mesh layer, and a non-slip mat layer;

FIG. 3 is a sectional diagram of a fixing member.

### DESCRIPTION OF REFERENCE SIGNS

| Reference sign | Name | Reference sign | Name |
|---|---|---|---|
| 10 | Sliding mat | 20 | Mesh layer |
| 30 | Smooth panel layer | 40 | Non-slip mat |
| 31 | Smooth surface | 50 | Fixing member |
| 60 | Hot melt adhesive | 51 | Inserting opening |
| | layer | | |
| 70 | Fixing hole | 52 | Fixing column |

The realization, functional characteristics and advantages of the objective of the utility model will be further described with reference to the drawings in conjunction with the embodiments.

### DETAILED DESCRIPTION OF EMBODIMENTS

The following clearly and completely describes the technical solutions in embodiments of the utility model in conjunction with the drawings in the embodiments of the utility model. Obviously, the described embodiments are only a part of the embodiments of the utility model, rather than all embodiments. Based on the embodiments of the utility model, all other embodiments obtained by the person skilled in the art without creative labor shall fall within the protection scope of the utility model.

It should be noted that if the embodiments of the utility model involve directional indications (such as up, down, left, right, front, back . . . ), the directional indications are only used to explain a relative position relationship and movement among various components under a certain posture (as shown in the accompanying drawings). If a specific posture changes, the directional indication also changes accordingly.

In addition, if there are descriptions of terms such as “first”, “second” and the like in the embodiments of the utility model, the descriptions of the terms such as “first”, “second” and the like are merely intended for a purpose of description, and shall not be understood as an indication or implication of relative importance or implicit indication of a quantity of indicated technical features. Therefore, the features defined with “first” and “second” can explicitly or implicitly include at least one of the features. In addition, the meaning of “and/or” in the whole text is to include three parallel schemes. Taking “A and/or B” as an example, “A and/or B” includes scheme A, scheme B, or a scheme that A and B are satisfied at the same time. In addition, the technical solutions between the various embodiments may be combined with each other, but should be based on what may be achieved by those skilled in the art. When a combination of technical solutions is contradictory or cannot be achieved, it should be considered that such a combination of technical solutions does not exist, and also does not fall within the scope of protection required by the utility model.

The utility model provides a sliding mat 10.

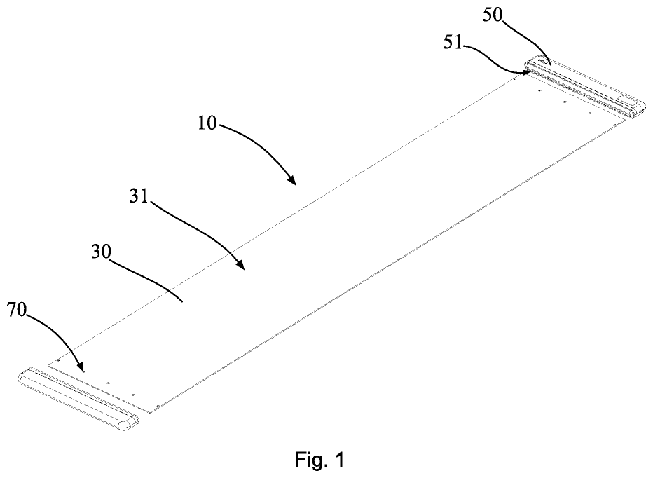

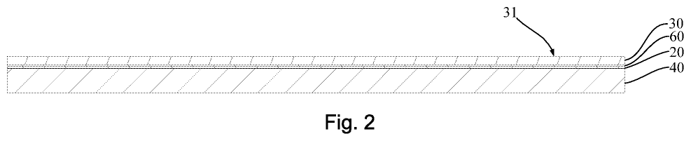

In the embodiment of the utility model, as shown in FIGS. 1 and 2, the sliding mat 10 includes;
a non-slip mat layer 40 located at a lower portion;
a smooth panel layer 30 located at an upper portion;
a mesh layer 20 bonded on the non-slip mat layer 40 by thermal compounding and located between the non-slip mat layer 40 and the smooth panel layer 30; and,
a hot melt adhesive layer 60 penetrating the mesh layer 20 and configured to bond the smooth panel layer 30 and the non-slip mat layer 40 together.

In this embodiment, the sliding mat 10 is used for a user to slide on a smooth surface by force, thereby achieving an effect of fitness. The smooth panel layer 30 is located on the upper portion of the sliding mat 10. A top of the smooth panel layer 30 is a smooth surface 31. The specific smooth panel layer 30 can be made of polytetrafluoroethylene, polyethylene, polypropylene, polycarbonate or a material made of polytetrafluoroethylene, polyethylene, polypropylene, polycarbonate combined with each other, which is not limited herein. A product made of the forgoing materials has the characteristics of a small friction coefficient and low adhesion. It should be explained that the forgoing materials are disclosed existing materials, such as polypropylene for short PP, which is a thermoplastic synthetic resin with excellent performance, and a colorless, odorless and nontoxic translucent thermoplastic lightweight general plastic with chemical resistance, heat resistance, electrical insulation, high strength mechanical properties and good high wear-resistant processability.

The non-slip mat 40 is configured to prevent the user from being injured due to an unstable center of gravity caused by synchronous movement of the sliding mat 10 when a user slides on the sliding mat 10. The non-slip mat 40 can be made of chloroprene rubber, nitrile rubber, polyvinyl chloride, thermoplastic rubber, cork or silica gel, which has no specific restriction herein. The material has the characteristics of a large friction coefficient and less peculiar smell. What needs to be explained is that, the forgoing materials are disclosed existing materials, such as neoprene, which is a synthetic rubber produced by polymerization of chloroprene as a main raw material, is widely used in a weathering resistant product, viscose soles, coatings, rocket fuels and other fields, and has excellent oil resistance, high wear resistance, good heat resistance and strong adhesion.

The mesh layer 20 is configured to limit a stretching range of the smooth panel layer 30 and the non-slip mat layer 40. The smooth panel layer 30 and the non-slip mat layer 40 are prevented from being pulled off. Specifically, the mesh layer 20 is arranged between the smooth panel layer 30 and the non-slip mat layer 40. The mesh layer 20 is pasted on the non-slip mat layer 40 via a thermal compounding process. At the same time, a hot melt adhesive is provided between the smooth panel layer 30 and the non-slip mat layer 40 to form the hot melt adhesive layer 60. The smooth panel layer 30 and the non-slip mat layer 40 are fixed to each other by the hot melt adhesive layer 60. It should be explained that the hot melt adhesive layer 60 partially penetrates into the mesh layer 20, thereby effectively reducing influence of bubbles generated in the hot melt adhesive layer 60 on adhesion stability of the smooth panel layer 30 and the non-slip mat layer 40.

It should be explained that the hot melt adhesive layer 60 is a layer structure formed by a hot melt adhesive. The hot melt adhesive is a disclosed existing material, and is a plastic adhesive. A physical state of the hot melt adhesive changes with change of temperature in a certain temperature range, with chemical characteristics remained unchanged. The hot melt adhesive is non-toxic and tasteless, and belongs to an environment-friendly chemical product. The hot melt adhesive is used in many scenes, such as furniture, fabrics and so on. At the same time, the thermal compounding process is an existing conventional compounding process, and is a process of slightly melting a surface of an object by heating the object, and then compounding other objects with a melted surface to connect the two objects together.

In addition, the smooth panel layer 30, the mesh layer 20, and the non-slip mat layer 40 are all made of an elastic material or a flexible material, so as to facilitate the user to fold or roll up the sliding mat 10 for storage.

According to the technical solution of the utility model, the smooth panel layer 30 and the non-slip mat layer 40 are arranged on opposite sides of the mesh layer 20, respectively. The smooth panel layer 30 is arranged on an upper portion of the sliding mat 10, and a side of the smooth panel layer far away from the mesh layer 20 is arranged as a smooth surface 21 so that a user slides on the smooth surface 21 to achieve a fitness effect. The mesh layer 20 is bonded to a surface of the non-slip mat layer 40 via a thermal compounding process. At the same time, the hot melt adhesive layer 60 is arranged between the smooth panel layer 30 and the non-slip mat layer 40. The hot melt adhesive layer 60 permeates the mesh layer 20, so that the smooth panel layer 30, the mesh layer 20, and the non-slip mat layer 40 are relatively fixed. The mesh layer 20 is thermally compounded to the non-slip mat layer 40, and the hot melt adhesive layer 60 permeates the mesh layer 20, thereby effectively improving a structural strength of the sliding mat 10, and further improving practicability of the sliding mat 10.

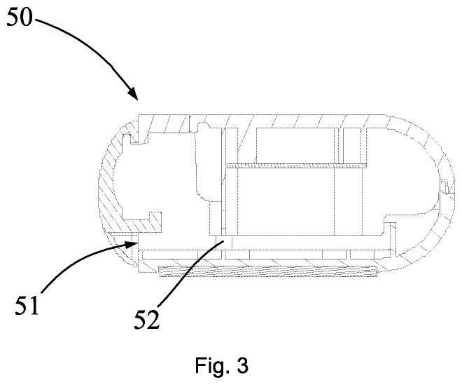

Further, as shown in FIGS. 1 and 3, the sliding mat 10 further includes fixing members 50 fixed to opposite ends of the non-slip mat 40. In this embodiment, the fixing member 50 is configured to fix the non-slip mat 40 on the ground, to prevent a user from being injured when the non-slip mat 40 moves away from the sliding mat 10 due to movement of the non-slip mat 40. Specifically, two fixing members 50 are provided, and arranged at both ends of the non-slip mat 40 in a longitudinal direction. When the user uses the sliding mat 10, the fixing members 50 are fixed on the ground, thereby effectively preventing the non-slip mat 40 from being displaced, and effectively improving the practicability of the sliding mat 10.

Further, the fixing member 50 is provided with an inserting opening 51 for extending the non-slip mat 40 into the fixing member 50. A fixing column 52 is arranged inside the fixing member 50. Two opposite ends of the non-slip mat 40 are opened and provided with fixing holes 70. The non-slip mat 40 passes through the inserting opening 51 and is inserted into the fixing member 50. The fixing column 52 is located in the fixing holes 70, thereby fixing the fixing member 50 and the non-slip mat 40 relatively.

Further, as shown in FIGS. 1 and 2, the smooth panel layer 30 is made of a polypropylene material containing a slipping agent. In the embodiment, the smooth panel layer 30 is preferably made from a mixture of the polypropylene material and the slipping agent. The polypropylene and the slipping agent are disclosed existing materials. The polypropylene material has colorless, tasteless and nontoxic properties. Compared with other materials, the polypropylene material is more environmentally friendly and safe. The slipping agent is an auxiliary agent to improve a hand feeling of leather while also being able to enhance waterproof, mildew-proof, wet rubbing resistance and other properties of the leather, and can also solve a problem of stickiness. The slipping agent is mixed with the polypropylene material, which can effectively improve smoothness and durability of the smooth panel layer 30, thus effectively improving practicability of the smooth panel layer 30.

Further, as shown in FIGS. 1 and 2, the mesh layer 20 is made of mutispandex. In the embodiment, the mutispandex is a disclosed existing material and specifically a 100% polyester fabric, which has high air permeability and tensile resistance, can effectively absorb the hot melt adhesive layer 60 to improve adhesion stability between the smooth panel layer 30 and the non-slip mat layer 40, and can also prevent the smooth panel layer 30 and the non-slip mat layer 40 from being excessively stretched and breaking at the same time, thus effectively improving structural stability of the sliding mat 10.

Further, as shown in FIGS. 1 and 2, the non-slip mat 40 is made of rubber. In the embodiment, the rubber is a disclosed existing material and a high elastic polymer material with reversible deformation. After being processed, the rubber has better wear resistance, aging resistance, and elasticity, which can effectively improve a friction force between the sliding mat 10 and the ground, and further improve stability of the sliding mat 10 in use.

Further, a bottom of the non-slip mat 40 is provided with a non-slip structure having a concave-convex mesh texture for improving the friction force between the non-slip mat 40 and the ground.

Further, as shown in FIGS. 1 and 2, the smooth panel layer 30 has a thickness of no more than 0.8 mm and no less than 0.4 mm. The non-slip mat 40 has a thickness of no more than 5 mm and no less than 1 mm. The smooth panel layer 30, the mesh layer 20 and the non-slip mat 40 have a length of no more than 2400 mm and no less than 1400 mm. The smooth panel layer 30, the mesh layer 20 and the non-slip mat 40 have a width of no more than 700 mm and no less than 300 mm. In the embodiment, according to different use scenarios, a required size, scale, and dimension are also different. This product is mostly used indoors. Therefore, a sliding distance is short. Therefore, in the embodiment, the thickness of the smooth panel layer 30 is set to be no more than 0.8 mm and no less than 0.4 mm. The thickness of the non-slip mat layer 40 is set to be no more than 5 mm and no less than 1 mm. Under a condition of maintaining a structural strength of the sliding mat 10, the manufacturing cost of the sliding mat 10 is saved, thus effectively improving the practicability of the sliding mat 10.

In addition, since the sliding mat 10 is for home use, the length of the smooth panel layer 30, the mesh layer 20, and the non-slip mat layer 40 is set to be no more than 2400 mm and no less than 1400 mm. The width the smooth panel layer 30, the mesh layer 20, and the non-slip mat layer 40 is set to be no more than 700 mm and no less than 300 mm.

The forgoing is only a preferred embodiment of the utility model, and is not intended to limit the patent scope of the utility model. Under the inventive concept of the utility model, an equivalent structure variation made by the contents of the description and drawings of the utility model directly/indirectly applied to other related arts is included in the scope of patent protection of the utility model.

1. A sliding mat, comprising;
a non-slip mat layer located at a lower portion;
a smooth panel layer located at an upper portion;
a mesh layer bonded on the non-slip mat layer by thermal compounding and located between the non-slip mat layer and the smooth panel layer; and,
a hot melt adhesive layer penetrating the mesh layer and configured to bond the smooth panel layer and the non-slip mat layer together.

2. The sliding mat according to claim 1, wherein the sliding mat also comprises fixing members fixed at opposite ends of the non-slip mat layer.

3. The sliding mat according to claim 2, wherein the fixing member is provided with an inserting opening, a fixing column is arranged inside the fixing member; fixing holes are arranged at opposite ends of the non-slip mat layer; the non-slip mat layer is inserted in the fixing member via the inserting opening, and the fixing column is located in the fixing hole.

4. The sliding mat according to claim 1, wherein the smooth panel layer is made of a polypropylene material containing a slipping agent.

5. The sliding mat according to claim 4, wherein the mesh layer is made of mutispandex.

6. The sliding mat according to claim 5, wherein the non-slip mat layer is made of rubber.

7. The sliding pad according to claim 6, wherein a bottom of the non-slip mat layer is provided with a non-slip structure.

8. The sliding mat according to claim 7, wherein the non-slip structure has a concave-convex mesh texture.

9. The sliding mat according to claim 6, wherein the smooth panel layer has a thickness of no more than 0.8 mm and no less than 0.4 mm, and the non-slip mat layer has a thickness of no more than 5 mm and no less than 1 mm;
the smooth panel layer, the mesh layer, and the non-slip mat layer have a length of no more than 2400 mm and no less than 1400 mm, and the smooth panel layer, the mesh layer, and the non-slip mat layer have a width of no more than 700 mm and no less than 300 mm.

10. A sliding mat, comprising:
a non-slip mat layer located at a lower portion and made of rubber;
a smooth panel layer located at an upper portion, the smooth panel layer being made of a polypropylene material containing a slipping agent;
a mesh layer bonded on the non-slip mat layer via thermal compounding and located between the non-slip mat layer and the smooth panel layer, and the mesh layer being made of mutispandex; and,
a hot melt adhesive layer penetrating the mesh layer and configured to bond the smooth panel layer and the non-slip mat layer together.
